(19) United States
(12) Patent Application Publication
(10) Pub. No.: US 2005/0143038 A1
(43) Pub. Date: Jun. 30, 2005

(54) Very low intermediate frequency image rejection receiver with image interference detection and avoidance

(75) Inventor: Phil Lafleur, Ontario (CA)

Correspondence Address: BLANK ROME LLP, 600 NEW HAMPSHIRE AVENUE, N.W., WASHINGTON, DC, 20037, US

(73) Assignee: TransCore

(21) Appl. No.: 11/009,002

(22) Filed: Dec. 13, 2004

Related U.S. Application Data
(60) Provisional application No. 60/532,568, filed on Dec. 29, 2003.

(51) Int. Cl. H04B 1/10

(52) U.S. Cl. 455/296; 455/207

(57) ABSTRACT

A method and apparatus for minimizing image interference using a very low intermediate frequency image rejection receiver is disclosed. Image interference detection and avoidance by frequency plan adjustment within the very low intermediate frequency receiver image rejection receiver minimizes rejection requirements for an image reject mixer. Image rejection can be measured by switching between in-phase and out-of-phase image reject mixer output ports. Rejection may also be measured by creating a tri-mode image reject mixer. A set of linear equations allows rejection to be measured without requiring control of input signals and additional mixers.

### CROSS REFERENCE TO RELATED APPLICATION

This application claims priority to co-pending U.S. provisional application entitled, “Very Low Frequency Image Rejection Receiver with Image Interference Detection and Avoidance”, having Ser. No. 60/532,568, filed Dec. 29, 2003, which is entirely incorporated herein by reference.

### FIELD OF THE INVENTION

The present invention is generally related to radio frequency receivers and, more particularly, is related to an apparatus and method for mitigating image interference using a very low intermediate frequency (VLIF) receiver.

### BACKGROUND OF THE INVENTION

Many conventional radio receivers for use in portable communication devices, such as cellular telephones, are of the super-heterodyne type in which a radio signal to be received is first down-converted to an intermediate frequency (IF), which is still within the radio frequency range, and then further down-converted to a base-band signal having both in-phase and quadrature-phase components from which the information contained in the signal may be recovered. A conventional super-heterodyne receiver architecture is shown in FIG. 2. However, direct conversion receivers and very low IF receivers reduce costs by eliminating both a relatively high performance, and therefore, expensive, surface acoustic wave band-pass filter (for allowing the wanted IF signal to pass while blocking all unwanted IF signal enabling channels) and one of the two radio frequency local oscillators (LO) required in super-heterodyne receivers.

Direct conversion receivers immediately down-convert the received radio signal to a base-band signal, thus completely eliminating the IF stage. However, such receivers suffer from the formation of a very large unwanted DC component interfering with the base-band signal. That DC component is formed largely by leakage from the LO being received at the receiver antenna together with the unwanted signal, and also by offsets of the amplifiers and mixers in the receivers. A typical direct-down conversion receiver is shown in FIG. 3.

Undesired signals that cause a response at the IF frequency in addition to the desired signal are known as spurious responses. Spurious responses must be filtered out before reaching mixer stages and the heterodyne receiver. One spurious response is known as an image frequency, or image. An RF filter (known as a preselector filter) is required for protection against the image unless an image reject mixer is used. Image reject mixers reduce the image component during the mixing process and thus provide protection against the image.

Image rejection is integral to VLIF receivers. A typical VLIF receiver architecture is shown in FIG. 1. In VLIF receivers, sampling of the received signal is often performed directly at the intermediate frequency. VLIF receivers, because of the elimination of components related to multiple IFs, are generally lower cost than conventional super-heterodyne receivers. However, the cost savings is not achieved without problems such as spurious responses due to interference at the image frequency.

A principal difficulty in implementing a VLIF architecture is the design of an image rejection receiver with sufficient attenuation to reject the image. Front end filters, although effective for image rejection super-heterodyne architectures, due to the higher first IF, do not provide sufficient attenuation at VLIF image frequencies. That is often addressed by a single side-band mixer (image reject mixer). The image reject mixer uses phase cancellation to reject the image, while down-converting the desired signal.

To sufficiently reject the image, image reject mixers often employ complex tuning systems with feedback. Defining sufficient rejection depends on the signal levels likely to be present in the image band, and the desired signal-to-image ratio.

Thus, to further reduce the costs and facilitate the implementation of VLIF architectures, it would be desirable to reduce the rejection required from the image reject mixer. Hence, an unaddressed need exists in the art to address the aforementioned deficiencies and inadequacies.

### SUMMARY OF THE INVENTION

Embodiments of the present invention provide an apparatus and method for mitigating image interference using VLIF architecture. Instead of only trying to maximize rejection, the invention minimizes the amount of power in the image band. Thus, the method can be used independently, or in conjunction with maximizing rejection.

Briefly described, a preferred embodiment of the apparatus can be implemented as follows. The apparatus includes an image reject mixer that has two possible outputs, one output for the desired signal, and another output for the image. The image reject mixer is incorporated in the architecture of a VLIF receiver. The VLIF receiver includes a dynamically adjustable frequency plan. The dynamically adjustable frequency plan includes at least two adjustable frequency sources. A measuring device is used to measure the power at the two outputs of the image reject mixer. An algorithm is used in calculations for detecting and avoiding image interference.

In yet another embodiment of the invention, the VLIF receiver includes three modes, an upper side band (USB) mode, a lower side band (LSB) mode and a double-side band (DSB) mode. In this embodiment, the image detection and avoidance provided by the VLIF receiver includes a rejection measurement capability. Also in this embodiment, by using a system of linear equations, the rejection may be measured without requiring control of the input signals, or additional mixers.

In another embodiment of the invention, an image detection and avoidance receiver is disclosed with rejection measurement capability and rejection tuning. In this method, amplitude and phase adjustment capabilities are provided.

In one embodiment of the invention, an alternative method is used for measuring the image level. In this embodiment, to measure the power in the image band, a local oscillator is tuned to place the image frequency in the signal band of the mixer.

In another embodiment, the apparatus may include an image reject VLIF receiver with a dynamic frequency plan connected to a DSP. Image interference may be detected indirectly by received signal metrics, such as signal levels and noise levels. Based on that measurement, the frequency plan could be changed in an effort to minimize noise levels.

Embodiments of the present invention can also be viewed as providing methods for mitigating image interference. In that regard, one embodiment of such a method, among others, can be broadly summarized by the following steps: measuring power at the dual outputs of an image reject mixer; providing at least two adjustable frequency sources; employing and adjusting a frequency plan based on a signal-to-image interference ratio; and controlling the at least two adjustable frequency sources via the results from measuring the power at the dual outputs of the image reject mixer.

Other systems, methods, features and advantages of the present invention will be or become apparent to one with skill in the art upon examination of the following drawings and detailed description. It is intended that all such additional systems, methods, features and advantages be included within this description, be within the scope of the present invention, and be protected by the accompanying claims.

### BRIEF DESCRIPTION OF THE DRAWINGS

Many aspects of the invention can be better understood with reference to the following drawings. The drawings are not necessarily to scale, emphasis instead being placed upon clearly illustrating the principles of the present invention. Moreover, in the drawings, like reference numerals designate corresponding parts throughout the several views.

FIG. 1 is a block diagram of a VLIF receiver architecture;

FIG. 2 is a block diagram of a super-heterodyne receiver architecture;

FIG. 3 is a block diagram of a direct down-conversion receiver architecture;

FIG. 4 is a block diagram of a preferred embodiment of a receiver with image detection and avoidance;

FIG. 5 is a flow diagram for evaluating image detection and avoidance;

FIG. 6 is a graphical representation of an alternative method for measuring power in an image band by tuning an oscillator to place the image and the signal band of the image reject mixer;

FIG. 7 is a block diagram of an embodiment of the invention with image detection and avoidance, and having rejection measurement capability;

FIG. 8 is a block diagram of an embodiment of the invention using an image detection and avoidance receiver with rejection measure capability and rejection tuning; and

FIG. 9 is a flow diagram of an embodiment of the invention illustrating image detection and avoidance with receiver tuning.

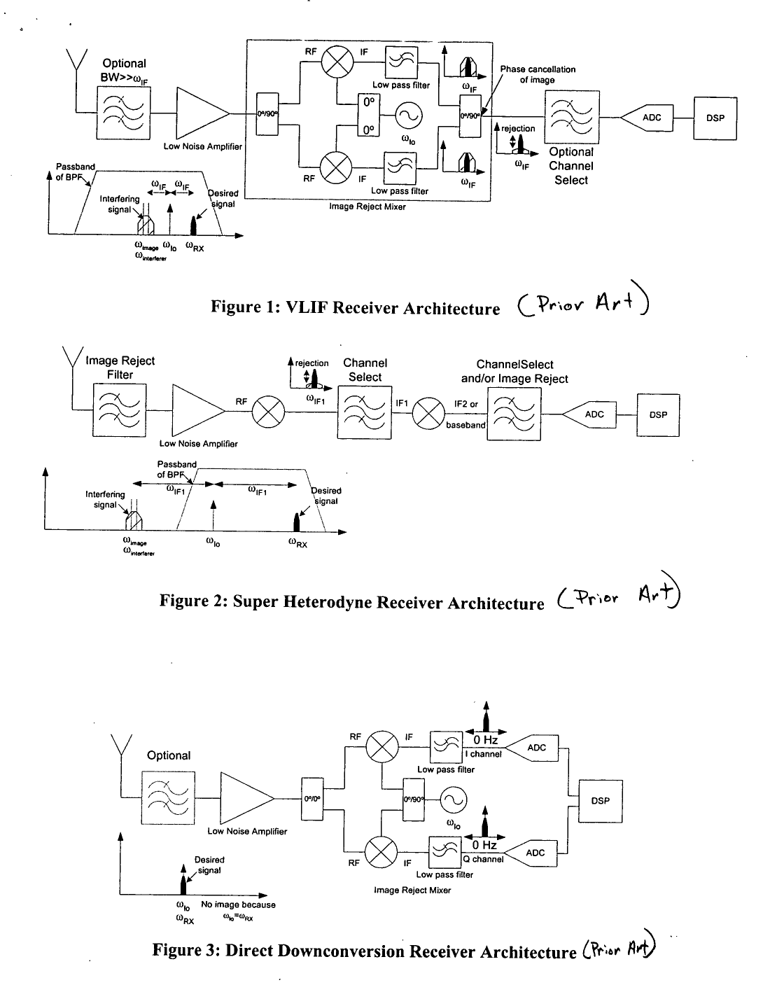

### DETAILED DESCRIPTION OF THE PREFERRED EMBODIMENT

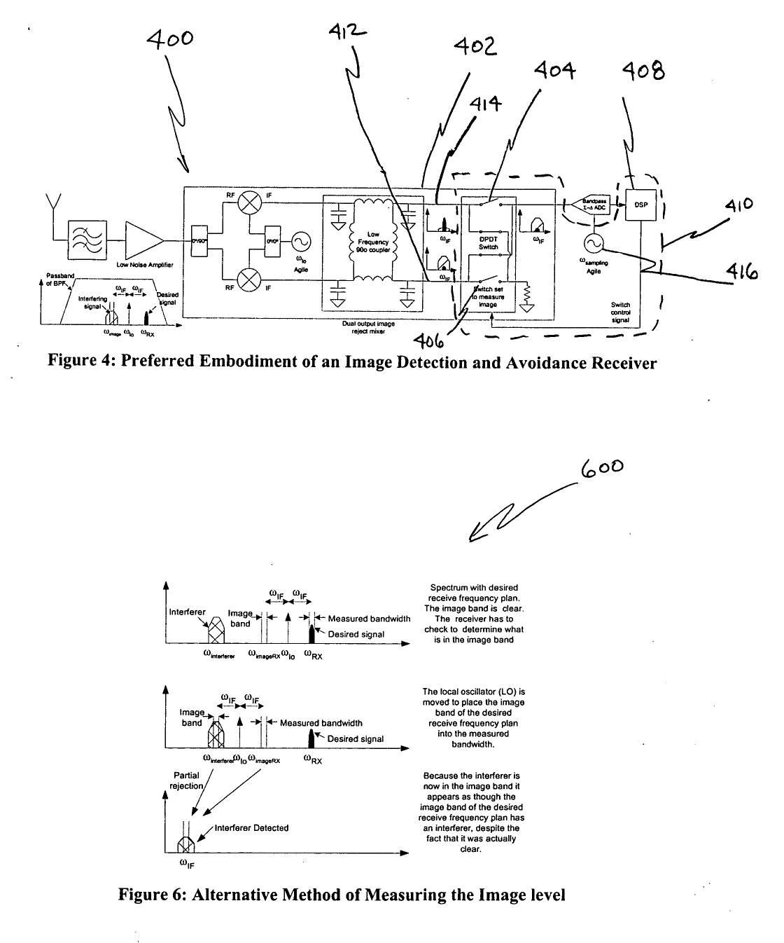

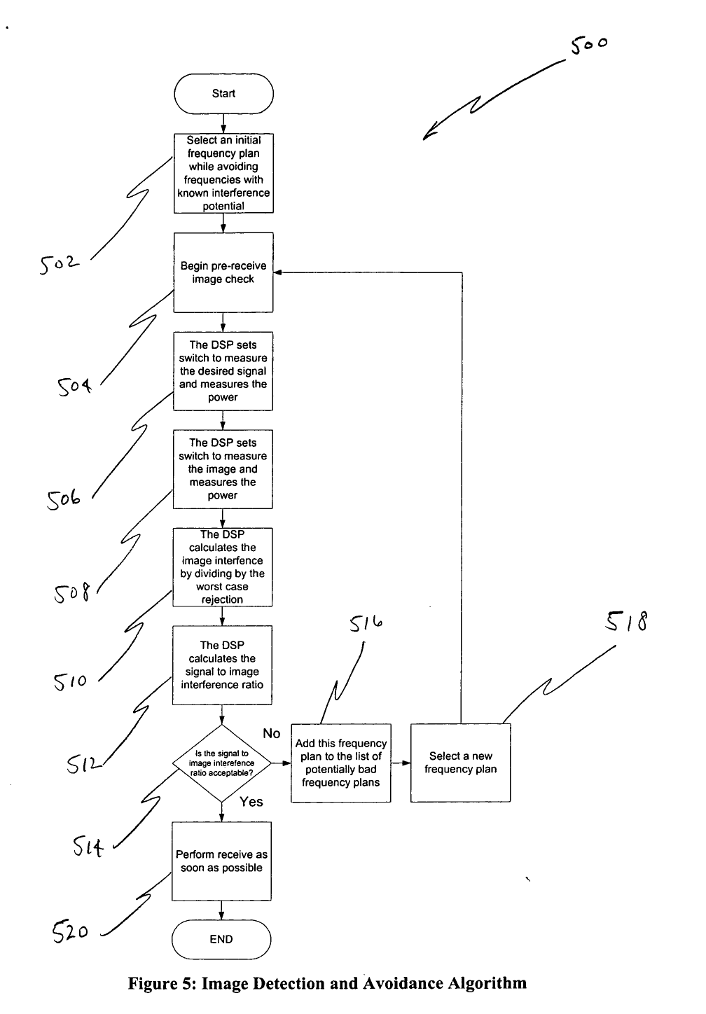

FIG. 4 illustrates a VLIF image rejection receiver 400 with image detection and avoidance. The VLIF receive 400 includes an image reject mixer 402 with dual outputs, one output 414 for a desired frequency signal and another output 412 for an image frequency signal. A measuring device for measuring power at the dual outputs of the image reject mixer 402 can be implemented using a suggested frequency plan. Immediately prior to a receiver operation, an image detection test would be performed. If a weak power level in the image band was detected, the receiver could proceed with the current frequently plan. If a strong image was detected, the frequency plan would be adjusted, and the image would be measured again. The cycle would continue until a frequency plan with a weak image was identified. An algorithm 500 illustrating how to implement the measuring device for sampling the frequency plan is illustrated in FIG. 5.

In FIG. 5, the algorithm 500 begins with the step of selecting an initial frequency plan while avoiding frequencies with known interference potential 502. Then, in step 504 a pre-receive image check is started. Next, a digital signal processor 408 sets a double pole double throw switch 404 to measure a desired signal and power, at step 506. In step 508, the digital signal processor sets the double pole double throw switch 404 to measure the image frequency signal and power. After the previous measurements, in step 510, the digital signal processor 408 calculates the image interference by dividing by the worse case rejection. The digital signal processor 408 then, in step 512, calculates the signal-to-image interference ratio. Step 514 addresses the issue as to whether the signal-to-image interference ratio is acceptable. If the ratio is not acceptable, then in step 516 the instruction is to add this frequency plan to the list of potentially bad frequency plans, select a new frequency plan at step 518, and return to the beginning of pre-receiving the image check, step at 504. If the signal-to-image interference ratio is acceptable in step 514, then in step 520 the receiver signal is immediately accepted.

As mentioned above, the digital signal processor 408, along with the double pole double throw switch 404, are used as a controller device for controlling the frequency plans used in the algorithm 500 for image detection and avoidance. Interestingly, a practical implementation could be to limit the amount of frequency plan iterations before eventually exiting the loop and reporting a failure (not shown).

In an alternative method 600, measuring the power in the image band could be achieved by tuning an oscillator 416 to place the image frequency signal in the signal band of the image reject mixer 402. (FIG. 6). This method has potential limitations in high interference-to-signal ratio environments. Because the very large interferer is now in the image band, limited image rejection ratio makes it appear as though the image band of the desired receiver frequency plan has an interferer, despite the fact that it was actually clear. This could lead to unnecessary frequency plan retuning. Thus, the approach using the image reject mixer 402 with the dual outputs, is preferred.

Simply measuring the power in the image band only determines image interference if the level of rejection is known, or can be sufficiently well estimated. If that is not the case, a measurement of rejection is also required. Measurement of rejection requires that the receiver 400 include three modes, upper-side band (USB) mode, lower-side band (LSB) mode, and double-side band (DSB) mode.

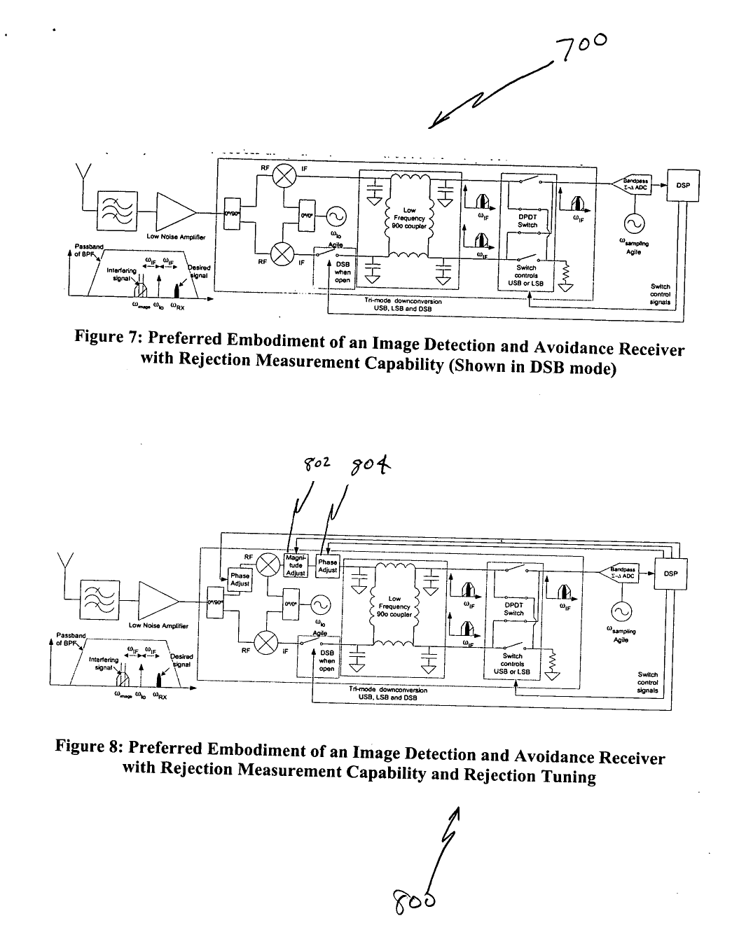

FIG. 7 illustrates a VLIF with image detection and avoidance and rejection measurement capability 700. To put the image reject mixer 402 in LSB mode, the double pole double throw switch 404 is cross-connected and the single pole single throw switch 706 is closed. To put the image reject mixer 402 in USB mode, the double pole double throw switch 404 is connected straight through and the single pole single throw switch 706 is closed. To put the image reject mixer 402 in DSB mode, the single pole single throw switch 706 is opened, and the double pole double throw switch 404 can be cross-connected or connected straight through. By measuring received power in the three modes, a linear system of equations is identified from which rejection can be calculated.

That system of equations for identifying rejection are as follows:

Equation 1: Power measured when the mixer is configured in USD mode.
P_{USB} Mode=P_{signal}+P_{image}/Rejection

Equation 2: Power measured when the mixer is configured in LSB mode.
P_{LSB} Mode=P_{image}+P_{signal}/Rejection

Equation 3: Power measured when the mixer is configured in DSB mode.
P_{DSB} Mode=P_{image}/K+P_{signal}/K_{g,} where K is the known additional loss factor introduced by only using one of the two branches of the mixer.

With rejection quantified, image interference can be calculated without assumptions.

With the aforementioned method to measure rejection, closed loop tuning is now possible. Closed loop tuning requires amplitude 802 and phase 804 adjustment capabilities (see FIG. 8). In situations with very stringent image rejection specifications, closed loop tuning along with image detection and avoidance could provide optimal performance by maximizing rejection and minimizing the image.

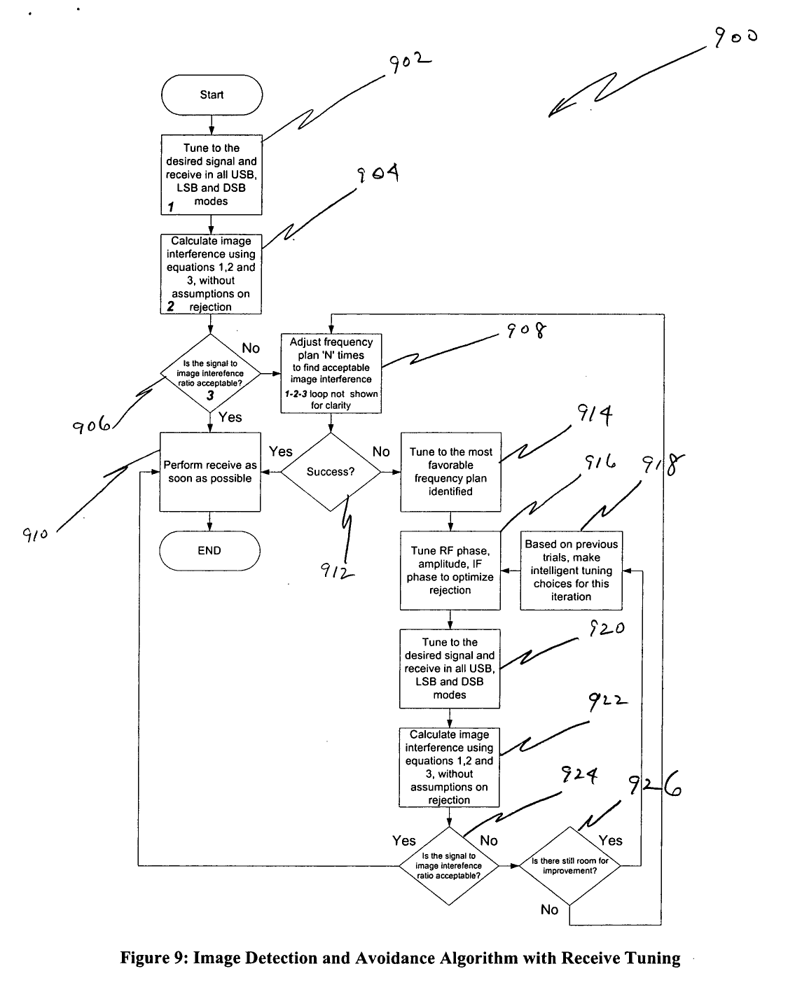

FIG. 9 illustrates another algorithm for configuring closed loop tuning, detection and avoidance 900 in a receiver. In step 902, one tunes to the desired signal and receives everything in USB, LSB and DSB modes. Then, in step 904, image interference is calculated using Equations 1, 2 and 3 (as referenced above) without assumptions on rejection. The question is then raised in step 906 as to whether the signal-to-image interference ratio is acceptable. If the answer to step 906 is no, then in step 908, the frequency plan is adjusted ‘N’ times to find an acceptable image interference. If the results to the question of step 906 are positive, then in step 910, one begins to receive the signal as soon as possible. Interestingly, in step 912, the question is asked whether an acceptable image interference is obtained. If the answer to that question is positive, then one moves on to step 910. If the answer to step 912 is negative, then in step 914, the most favorable frequency plan identified is acquired. In step 916, RF phase, RF amplitude, and IF phase are tuned to optimize rejection. The output of that step is then forwarded to step 920 to tune to the desired signal and receive in all USB, LSB and DSB modes. The image interference is then calculated using Equations 1, 2 and 3 without assumptions on rejection, step 922. The results of step 922 are then forwarded to a query step 924 where the question is asked as to whether the signal-to-image interference ratio is acceptable. If the answer to that question is positive, then one returns to step 910. If the results of step 924 are negative, then in step 926, the question is asked whether there is still room for improvement. If the answer to step 926 is yes, then one is transferred to step 918 which makes intelligent tuning choices based upon previous trials and then forwards those results to step 916. If the answer to step 926 is negative, then one is returned to step 908 where frequency plans are again tried ‘N’ times until one is found acceptable.

In another embodiment of the invention, the apparatus may include an image reject VLIF receiver with a dynamic frequency plan connected to a DSP. Image interference is detected indirectly by received signal metrics, such as signal levels and noise levels. In the case of image interference, a normal signal level with a high noise level could be indicative of image interference. Based on that measurement, the frequency plan could be changed in an effort to minimize noise in the image band, which could be observed as a return of the noise level to normal levels. However, this approach has limitations, primarily because of the indirect nature of the image interference measurement, as other reception impairments could be mistaken for image interference.

Furthermore, by including image interference detection and avoidance by frequency plan adjustment within a VLIF receiver architecture, rejection requirements for the image reject mixer are minimized and thereby, minimizing costs and facilitating implementation. By switching between in-phase and out-of-phase mixer output ports, image rejection can be measured. Thus, rejection requirements for the image reject mixer are minimized.

It should be emphasized that the above described embodiments of the present invention, particularly, any preferred embodiments are merely possible examples of implementations, merely set forth for a clear understanding of the principles of the invention. Many variations and modifications may be made to the above described embodiments of the invention without departing substantially from the spirit and principles of the invention. All such modifications and variations are intended to be included herein within the scope of this disclosure and the present invention and protected by the following claims.

1. A very low intermediate frequency image rejection receiver, comprising;
an image reject;
a measuring means for measuring image interference;
at least two adjustable frequency sources for the receiver;
a dynamically adjustable frequency plan for the receiver; and
a controller means for controlling said at least two adjustable frequency sources based on results from said measuring means.

2. The receiver according to claim 1, wherein said controller means is a digital signal processor.

3. The receiver according to claim 2, wherein said frequency plan is connected to the digital signal processor, and image interference is detected indirectly by received signal metrics.

4. A very low intermediate frequency image rejection receiver, comprising;
an image reject mixer with dual outputs;
a measuring means for measuring power at said dual outputs of said image reject mixer;
at least two adjustable frequency sources for the receiver;
a dynamically adjustable frequency plan for the receiver; and
a controller means for controlling said at least two adjustable frequency sources based on results from said measuring means.

5. A receiver according to claim 4, where dual outputs of said image reject mixer include one output for a desired frequency signal and another output for an image frequency signal.

6. A receiver according to claim 4, wherein said controller means comprises a double pole double throw switch and a single pole single throw switch controlled by a digital signal processor.

7. The receiver according to claim 4, wherein said at least two adjustable frequency sources include a desired signal band and an image signal band.

8. The receiver according to claim 4, wherein said dynamically adjustable frequency plan includes a first algorithm for detecting and avoiding image interference.

9. The receiver according to claim 5, further comprising a local oscillator that is tuned to place the image frequency signal in a signal band of said image reject mixer for measuring power in said image frequency signal output.

10. The receiver according to claim 4, wherein said measuring means further comprises a rejection means for measuring rejection.

11. The receiver according to claim 10, wherein said rejection means includes upper side band, lower side band and double side band modes for the image reject mixer.

12. The receiver according to claim 11, wherein said measuring means when the receiver is in the upper side band mode includes Equation 1: P_{USB} Mode=P_{signal}+P_{image}/Rejection

13. The receiver according claim 11, wherein said measuring means when the receiver is in the lower-side band mode includes Equation 2: P_{LSB} Mode=P_{image}+P_{signal}/Rejection

14. The receiver according to claim 11, wherein said measuring means when the receiver is in the double-side band mode includes Equation 3: P_{DSB} Mode=P_{image}/K+P_{signal}/K_{g}, where K is the known additional loss factor introduced by only using one of the two branches of the mixer.

15. The receiver according to claim 11, further comprising closed loop tuning.

16. The receiver according to claim 15, wherein the closed loop tuning comprises amplitude and phase adjustment capabilities.

17. The receiver according to claim 16, further comprising a second algorithm for closed loop tuning, detection and avoidance of the receiver.

18. A method for minimizing image interference using a very low intermediate frequency receiver, said method comprising the steps of:
employing an image reject mixer with dual outputs;
measuring power at the dual outputs;
providing at least two adjustable frequency sources;
employing and adjusting a frequency plan based on a signal to image interference ratio; and
controlling the at least two adjustable frequency sources via results from measuring power at the dual output.

19. The method according to claim 18, further comprising the step of employing a digital signal processor to control a double pole double throw switch and a single pole single throw switch when measuring power at the dual outputs.

20. The method according to claim 18, further comprising the step of employing a first algorithm for detecting and avoiding image interference.

21. The method according to claim 18, further comprising the step of employing a second algorithm for closed lube tuning, detection and avoidance of image interference.

22. The method according to claim 19, further comprising the step of equating rejection via ascertaining power at the dual outputs when the image reject mixer is configured in upper-side band, lower-side band and double-side band modes, respectively.

23. The method according to claim 22, comprising the step of ascertaining power at the dual outputs in the upper-side, lower-side, and double-side band modes of the image reject mixer by evaluating three linear system equations corresponding to switch positions of the double pole double throw and the single pole single throw switches.

24. A means for minimizing rejection requirements for an image reject mixer by including image interference detection and avoidance by frequency plan adjustment within a very low intermediate frequency receiver architecture.

25. The means according to claim 24, wherein image interference detection is achieved by switching between in-phase and out-of-phase image reject mixer output ports and measuring image rejection.

26. A method for minimizing image interference using an image reject very low intermediate frequency receiver with a dynamic frequency plan connected to a digital signal processor.

27. The method according to claim 26, wherein image interference is defeated indirectly by receiving signal metrics from signal levels and noise levels.
